(19) United States
(12) Patent Application Publication
(10) Pub. No.: US 2017/0017993 A1
(43) Pub. Date: Jan. 19, 2017

(54) SYSTEM AND METHOD OF USING ATTRIBUTION TRACKING FOR OFF-PLATFORM CONTENT PROMOTION

(71) Applicant: SPOTIFY AB, Stockholm (SE)

(72) Inventors: Steve Shirley, New York, NY (US); Gilles Deveaux, New York, NY (US); Brian Springer, New York, NY (US); Sean Kenny, New York, NY (US); Ankit Aggarawal, New York, NY (US); Abeyu Mengistu, New York, NY (US)

(21) Appl. No.: 15/212,064

(22) Filed: Jul. 15, 2016

Related U.S. Application Data
(60) Provisional application No. 62/193,493, filed on Jul. 16, 2015.

(51) Int. Cl. G06Q 30/02

(52) U.S. Cl. CPC G06Q 30/0246

(57) ABSTRACT

In accordance with an embodiment, described herein is a system and method of using attribution tracking for off-platform content promotion, for use in media content or other computing environments. A media campaign can be associated with a promoted content link (e.g., a URL) for use on a publisher web site. When the promoted content link is selected, for example by a user of a client media device, the user/device can be redirected to the media content environment. Client activity data can be logged to provide one or more campaign, content promoter, artist, date, user identification, or other data, which can be recorded as a promotion event. In response to the user/device performing additional downstream actions with regard to the promoted content, downstream events can be generated, and data pipelines used in combination with attribution windows, to correlate attribution of the downstream actions with particular media campaigns or content promoters.

### CLAIM OF PRIORITY

This application claims the benefit of priority to U.S. Provisional Patent Application No. 62/193,493, titled “SYSTEM AND METHOD OF USING ATTRIBUTION TRACKING FOR OFF-PLATFORM CONTENT PROMOTION”, filed Jul. 16, 2015, which application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to providing digital media content, and are particularly related to systems and methods of using attribution tracking for off-platform content promotion, in media content or other computing environments.

### BACKGROUND

Today's consumers enjoy the ability to access a tremendous amount of digital media content, such as music and videos, at any location or time of day, using a wide variety of media devices.

Media content environments, for example music streaming services such as Spotify, are ideally positioned to help promote an artist's works, and artist-related merchandise or other information. A media content promoter, for example a record label, talent agency, manager, or artist, can encourage or otherwise direct users to the media content environment, so that a user can click to play, or otherwise select, a promoted content, such as a promoted track.

However, after a user has selected a particular promoted content, the content promoter generally does not receive any feedback on the user's subsequent activities with regard to the promoted content. These are some examples of the types of environments within which embodiments of the invention can be used.

### SUMMARY

In accordance with an embodiment, described herein is a system and method of using attribution tracking for off-platform content promotion, for use in media content or other computing environments.

A media campaign can be associated with a promoted content link (e.g., a URL) for use on a publisher web site. When the promoted content link is selected, for example by a user of a client media device, the user/device can be redirected to the media content environment. Client activity data can be logged to provide one or more campaign, content promoter, artist, date, user identification, or other data, which can be recorded as a promotion event.

In response to the user/device performing additional downstream actions with regard to the promoted content, downstream events can be generated, and data pipelines used in combination with attribution windows, to correlate attribution of the downstream actions with particular media campaigns or content promoters.

### BRIEF DESCRIPTION OF THE FIGURES

FIG. 1 illustrates an example of a media content environment, in accordance with an embodiment.

FIG. 2 illustrates a system which supports attribution tracking for off-platform content promotion, in accordance with an embodiment.

FIG. 3 further illustrates a system which supports attribution tracking for off-platform content promotion, in accordance with an embodiment.

FIG. 4 further illustrates a system which supports attribution tracking for off-platform content promotion, in accordance with an embodiment.

FIG. 5 is a flowchart that illustrates a process for supporting attribution tracking for off-platform content promotion, in accordance with an embodiment.

FIG. 6 is a flowchart that further illustrates a process for supporting attribution tracking for off-platform content promotion, in accordance with an embodiment.

FIG. 7 illustrates an example table or data structure that can be used to record activity data, in accordance with an embodiment

### DETAILED DESCRIPTION

As described above, a media content promoter, for example a record label, talent agency, manager, or artist, can encourage or otherwise direct users to the media content environment, so that a user can click to play, or otherwise select, a promoted content, such as a promoted track. However, after a user has selected a particular promoted content, the content promoter generally does not receive any feedback on the user's subsequent activities with regard to the promoted content.

To address this, in accordance with an embodiment, described herein is a system and method of using attribution tracking for off-platform content promotion, for use in media content or other computing environments.

### Media Content Environment

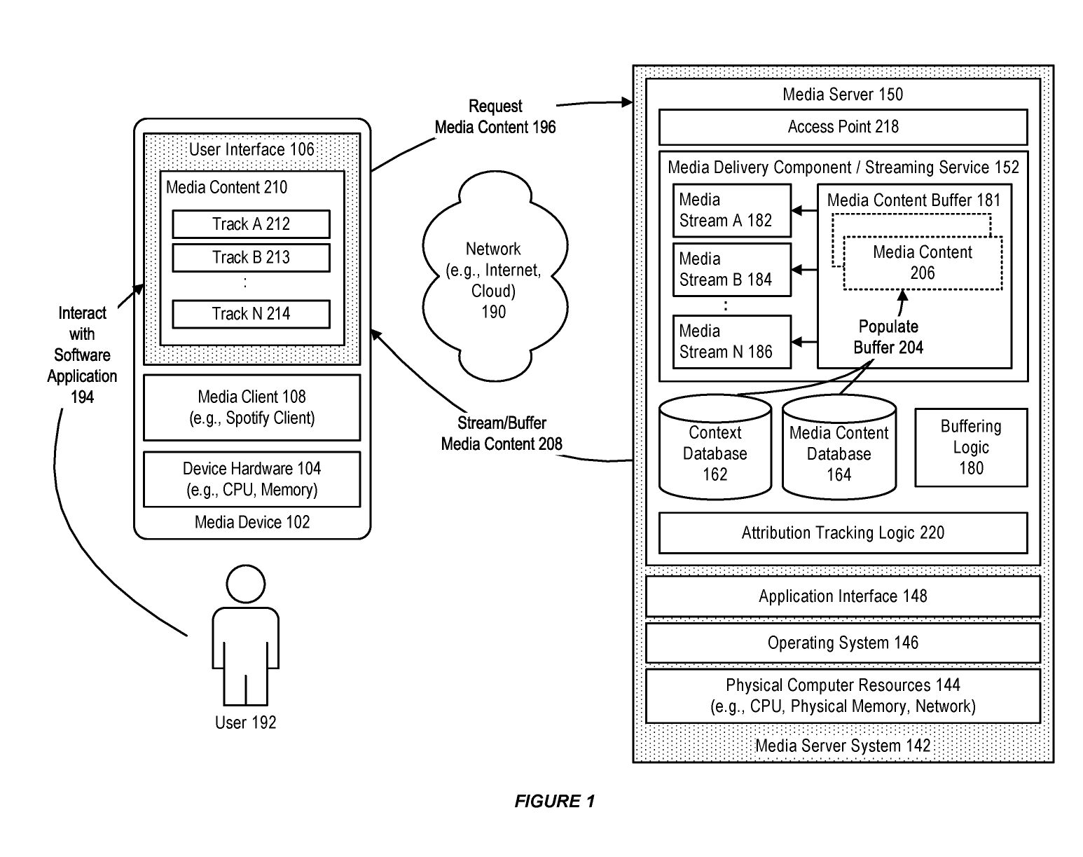

FIG. 1 illustrates an example of a media content environment, in accordance with an embodiment.

As illustrated in FIG. 1, in accordance with an embodiment, a media device 102, operating as a client device, can receive and play media content provided by a media server system 142 (media server), or by another system or peer device.

In accordance with an embodiment, the media device can be, for example, a personal computer system, handheld entertainment device, tablet device, smartphone, television, audio speaker, in-car entertainment system, or other type of electronic or media device that is adapted or able to prepare a media content for presentation, control the presentation of media content, and/or play or otherwise present media content.

In accordance with an embodiment, each of the media device and the media server can include, respectively, one or more physical device or computer hardware resources 104, 144, such as one or more processors (CPU), physical memory, network components, or other types of hardware resources.

In accordance with an embodiment, the media device can optionally include a touch-enabled or other type of display screen having a user interface 106, which is adapted to display media options, for example as an array of media tiles, thumbnails, or other format, and to determine a user interaction or input. Selecting a particular media option, for example a particular media tile or thumbnail, can be used as a command by a user and/or the media device, to the media server, to download, stream or otherwise access a corresponding particular media content item or stream of media content.

In accordance with an embodiment, the media device can also include a software media application or media client 108 (e.g., in a Spotify environment, a Spotify client), together with an in-memory client-side media content buffer, and a data buffering logic or software component, which can be used to control the playback of media content received from the media server, for playing either at a requesting media device (i.e., a controlling device) or at a controlled media device (i.e., a controlled device), in the manner of a remote control. A connected media environment firmware, logic or software component enables the media devices to participate within a connected media environment.

In accordance with an embodiment, the media server can include an operating system 146 or other processing environment, which supports execution of a media server application 150 that can be used, for example, to stream music, video, or other forms of media content to a client media device, or to a controlled device.

In accordance with an embodiment, one or more application interface(s) 148 can receive requests from client media devices, or from other systems, to retrieve media content from the media server. A context database 162 can store data associated with the presentation of media content by a client media device, including, for example, a current position within a media stream that is being presented by the media device, or a playlist associated with the media stream, or one or more previously-indicated user playback preferences.

In accordance with an embodiment, the media server can transmit context information associated with a media stream to a media device that is presenting that stream, so that the context information can be used by the device, and/or displayed to the user. The context database can be used to store a media device's current media state at the media server, and synchronize that state between devices, in a cloud-like manner. Alternatively, media state can be shared in a peer-to-peer manner, wherein each device is aware of its own current media state, which is then synchronized with other devices as needed.

In accordance with an embodiment, a media content database 164 can include media content, for example music, songs, videos, movies, or other types of media content, together with metadata describing that media content. The metadata can be used to enable users and client media devices to search within repositories of media content, to locate particular media content items.

In accordance with an embodiment, a buffering logic or software component 180 can be used to retrieve or otherwise access media content items, in response to requests from client media devices or other systems, and to populate a server-side media content buffer 181, at a media delivery component or streaming service 152, with streams 182, 184, 186 of corresponding media content data, which can then be returned to the requesting device or to a controlled device.

In accordance with an embodiment, a plurality of client media devices, media server systems, and/or controlled devices, can communicate with one another using a network, for example the Internet 190, a local area network, peer-to-peer connection, wireless or cellular network, or other form of network. A user 192 can interact 194 with the user interface at a client media device, and issue requests to access media content, for example the playing of a selected music or video item either at their device, or at a controlled device; or the streaming of a media channel or video stream to their device, or to a controlled device.

For example, in accordance with an embodiment, the user's selection of a particular media option can be communicated 196 to the media server, via the server's media application interface. The media server can populate its media content buffer at the server 204, with corresponding media content, 206 including one or more streams of media content data. The media server can then communicate 208 the selected media content to the user's media device, or to the controlled device as appropriate, where it can be buffered in a media content buffer for display as media content 210, for example as tracks 212, 213, 214, for selection and playing at the device.

In accordance with an embodiment, the system can include a server-side media gateway or access point 218, or other process or component, which operates as a load balancer in providing access to one or more servers, for use in processing requests at those servers. The system can enable communication between a client media device and a server, via an access point at the server, and optionally the use of one or more routers, to allow requests from the client media device to be processed either at that server and/or at other servers.

For example, in a Spotify media content environment, Spotify clients operating on media devices can connect to Spotify back-end processes via a Spotify “accesspoint”, which forwards client requests to other servers, on behalf of the client or end user.

In accordance with an embodiment, the system can also include an attribution tracking logic 220, which can be used to support attribution tracking for off-platform content promotion, as further described below.

### Media Content Promotion

As described above, a media content promoter, for example a record label, talent agency, manager, or artist, can encourage or otherwise direct users to the media content environment, so that a user can click to play, or otherwise select, a promoted content, such as a promoted track.

However, if the content promoter does not receive any feedback on the user's subsequent activity with regard to the promoted content (such as, for example, whether the user continued to play a promoted track; or whether the user chose to follow the associated artist within the media content environment; or whether the user saved the promoted track after listening), then the content promoter will not know if their efforts have been successful in promoting that content.

To address this, in accordance with an embodiment, described herein is a system and method of using attribution tracking for off-platform content promotion, for use in media content or other computing environments, which allows for the collection and sharing of information that illustrates the impact of promotional media campaigns.

Such information is particularly beneficial for content promoters, since it allows those promoters to evaluate success in promoting content to a streaming media environment, without resorting to alternate methods where a promotional impact might otherwise be measured, for example, by downloadable sales or play counts.

### Attribution Tracking

In accordance with an embodiment, when a promotion event is initiated off-platform, the system can collect actions performed by a user/device that had selected a particular promotion, and that are related to a promoted media content.

For example when a click-event is detected at an off-platform publisher site (e.g., Twitter, Facebook, Google, or another site or service that supports promotions), in connection with the promotion of a particular, e.g., artist or music track, the system can collect actions performed by the user/device that had clicked on or otherwise selected the particular promotion, and that are related to that promoted artist or music track.

In a media content environment, some examples of the types of activities or actions that can be collected include: track play post track/album/artist promotion; track play complete post track/album/artist promotion; track/album/artist save post track/album/artist promotion; follow for artist post track/album/artist promotion; social share for track/album/artist post track/album/artist promotion; or user conversion to fan of artist post track/album/artist promotion.

Other types of media content or computing environments can be associated with other types of activities or actions, as supported by those types of environments.

In accordance with an embodiment, one or more attribution windows, each of which is defined by a period of time that follows, i.e., is post a particular promotion event, can be determined, for use by the system in addressing various use cases.

For example, in accordance with an embodiment, using a six-month attribution window, the system can be configured to make a determination that a downstream activity, such as a play action for a particular promoted music artist, which is initiated or detected within the six-month period after the user had clicked on a particular promotion for that artist, can be attributed to a particular promotion event.

In accordance with an embodiment, other attribution windows can be used to provide attributions for actions that are initiated or are detected within other time periods, for example within a one-week period, or within a one-day period, post a particular promotion event.

In accordance with an embodiment, data describing each of a plurality of promotion events, and any subsequent actions, can be collected or logged by the system, and an appropriate attribution window determined for use with that data, to address particular use cases.

### System Architecture

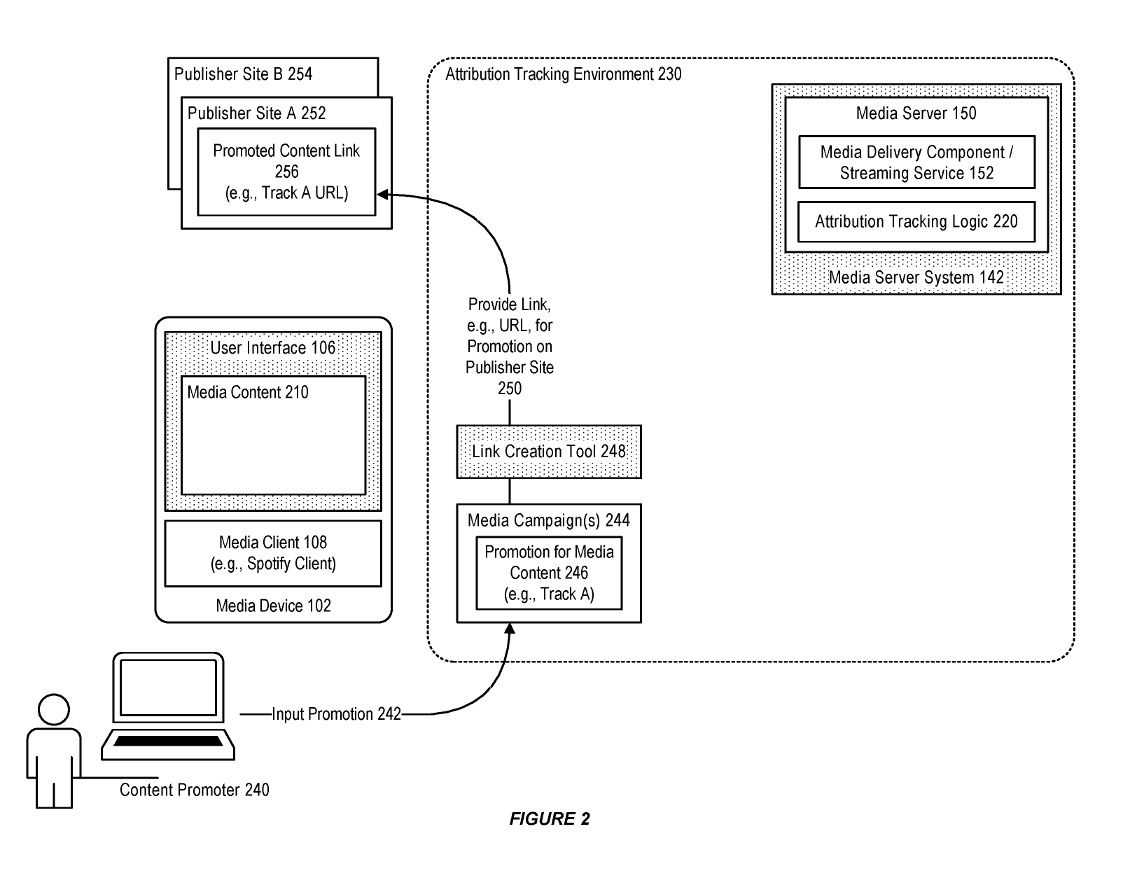

FIG. 2 illustrates a system which supports attribution tracking for off-platform content promotion, in accordance with an embodiment.

As illustrated in FIG. 2, in accordance with an embodiment, a content promoter 240 can provide, as input 242 to the system, a definition of a media campaign 244, including a promotion for a particular media content 246 (e.g., Track A).

In accordance with an embodiment, a link creation tool 248, for example a software application program, can be used to create or otherwise provide 250, a promoted content link (e.g., a URL), which can be used as a content promotion on a publisher site.

In accordance with an embodiment, the promoted content link can be customized to take into account factors such as a particular publisher site, campaign identifier, or a value unique to the content link.

The content promoter can then use the promoted content link 256, as a promotion on one or more publisher sites A 252 and/or B 254.

For example, the content promoter can use a promoted content link, such as a Track A URL, in association with a promotion for Track A, on one or more publisher sites (e.g., Twitter, Facebook, or Google) that supports promotions.

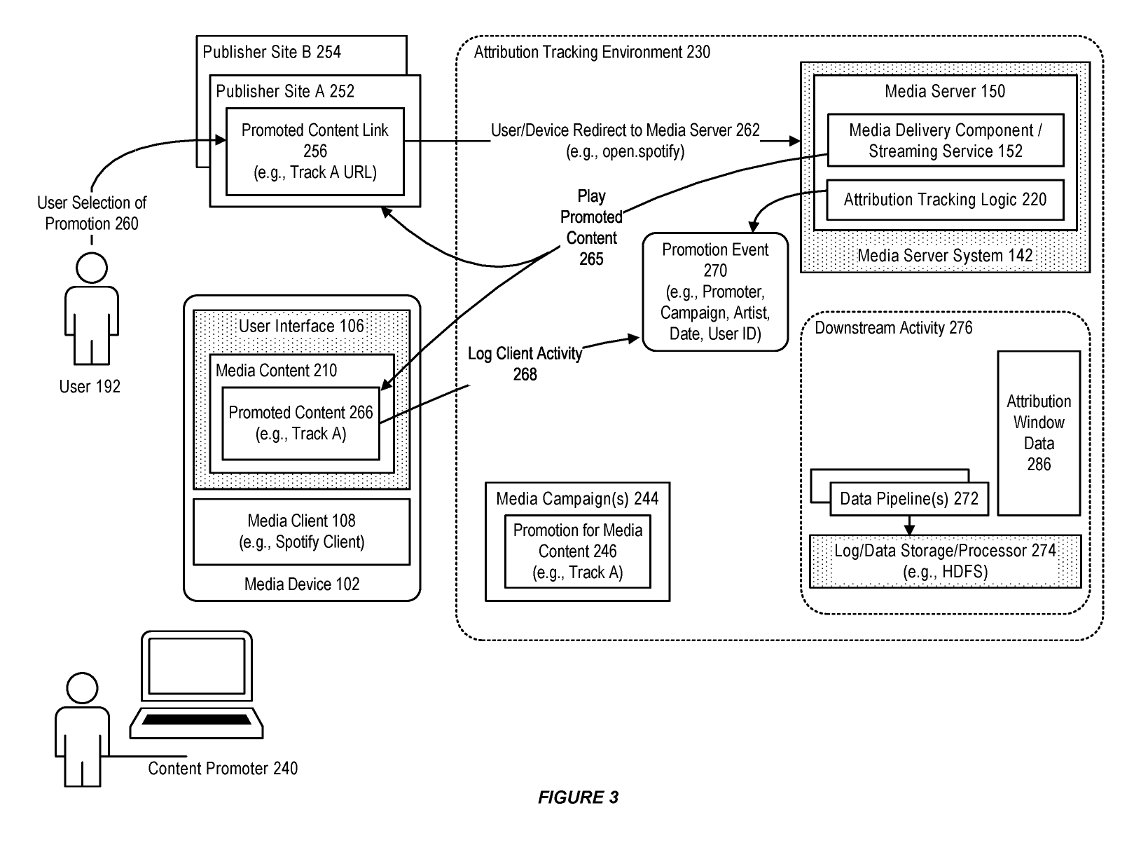

FIG. 3 further illustrates a system which supports attribution tracking for off-platform content promotion, in accordance with an embodiment.

As illustrated in FIG. 3, in accordance with an embodiment, when a user/device selects a particular promoted content 260, for example by a user clicking or otherwise causing the promoted content link to be selected (e.g., by selecting the Track A URL), the user/device can be redirected 262 to access the media content environment (e.g., in a Spotify environment to open.spotify.com), to play or otherwise access the promoted content.

The promoted media content can then be played 265, either at a requesting site/device, and/or at the media device 266, or at another device.

In accordance with an embodiment, a client activity data is logged 268 by the system, and is used to provide one or more of a campaign, content promoter, artist, date, user identification, or other data, which can be recorded by the system as a promotion event 270.

As further described below, in accordance with an embodiment, the logged data can then be used, for example, with one or more data pipelines 272, and a log/data storage/processor 274 (e.g., an Apache Hadoop HDFS environment), to evaluate downstream activity 276 by the user/device, with regard to the promoted content, within a particular attribution window or time period, as defined by an attribution window data 286.

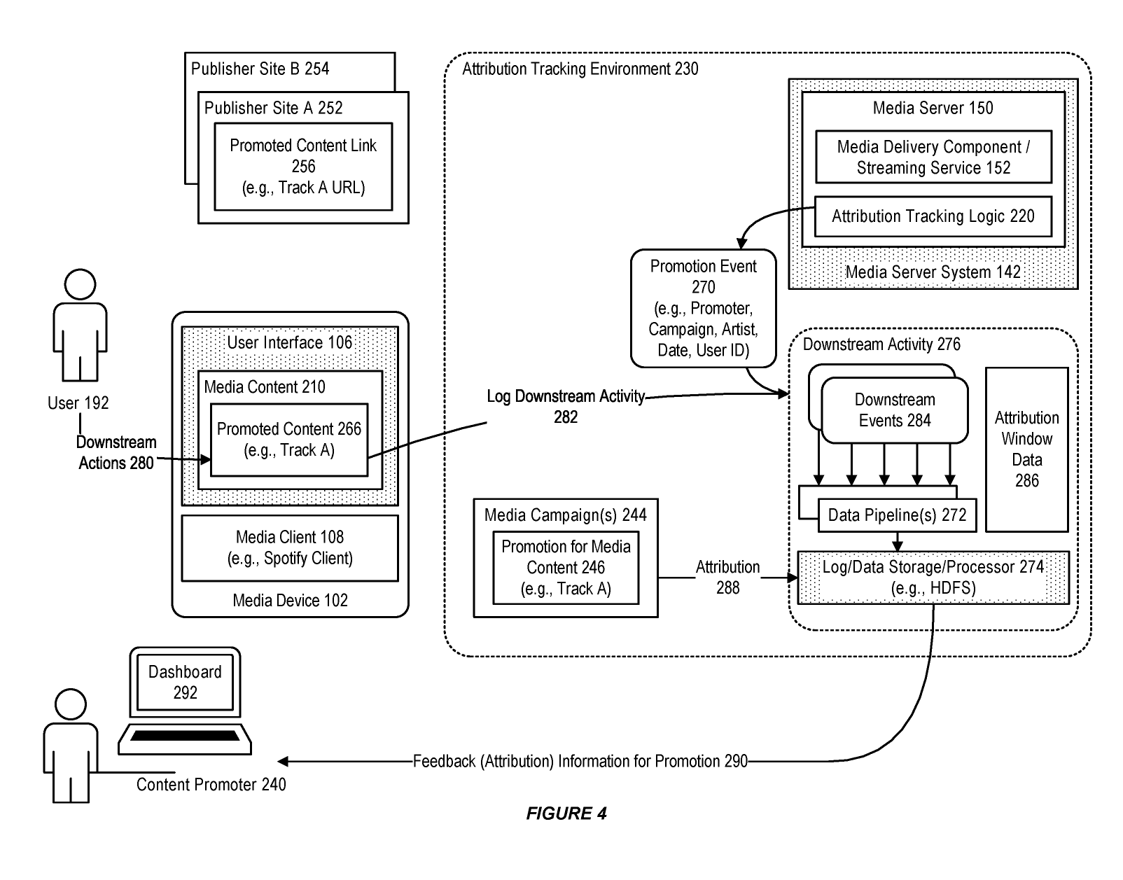

FIG. 4 further illustrates a system which supports attribution tracking for off-platform content promotion, in accordance with an embodiment.

As illustrated in FIG. 4, while, or in response to, the user performing additional downstream actions 280, for example, by continuing to play a promoted track, following a promoted artist within the media content environment, or saving a promoted track after listening, such actions are logged 282 by the system as downstream activity, to generate downstream events 284.

In accordance with an embodiment, the system can then use an attribution window, to correlate attribution 288 of the downstream actions, based on these events, with a particular media campaign or content promoter.

Although the process may not be able to prove that a particular action is definitively attributed to a particular promotion event, it can be used to infer such attribution, which is sufficient for many use cases.

In accordance with an embodiment, the system can then provide attribution feedback information 290, for example in the form of reports to the content promoter, and/or by displaying the information in the form of an artist dashboard 292.

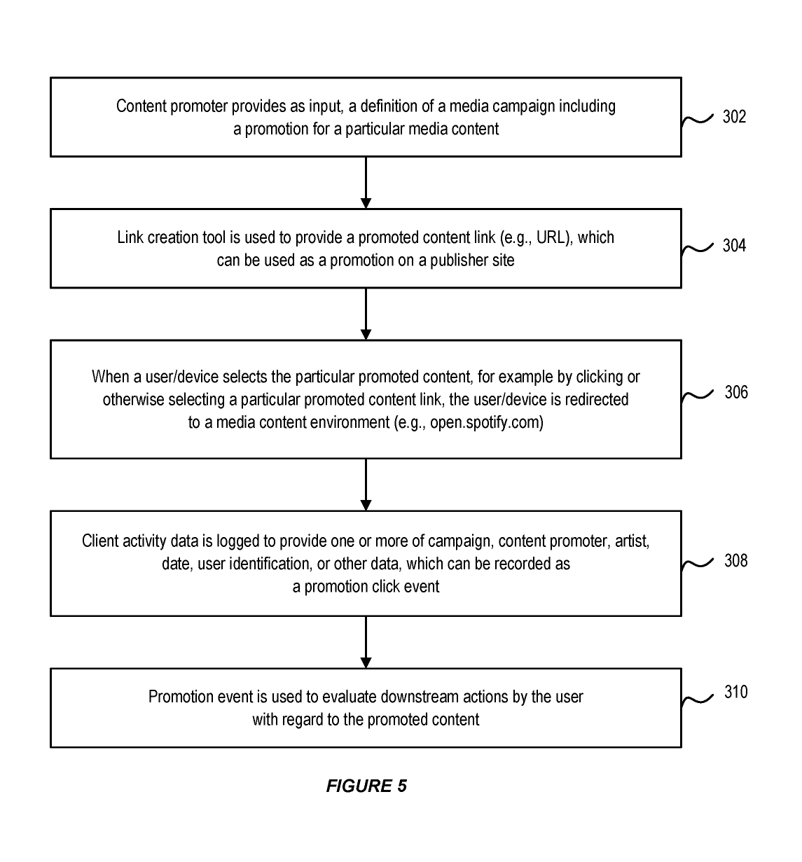

FIG. 5 is a flowchart that illustrates a process for supporting attribution tracking for off-platform content promotion, in accordance with an embodiment. As illustrated in FIG. 5, at step 302, a content promoter provides as input, a definition of a media campaign including a promotion for a particular media content.

At step 304, a link creation tool is used to provide a promoted content link (e.g., URL), which can be used as a promotion on a publisher site.

At step 306, when a user/device selects the particular promoted content, for example by clicking or otherwise selecting a particular promoted content link, the user/device is redirected to a media content environment (e.g., open.spotify.com).

At step 308, client activity data is logged to provide one or more of a campaign, content promoter, artist, date, user identification, or other data, which can be recorded as a promotion event.

At step 310, the promotion event is used to evaluate downstream actions by the user with regard to the promoted content.

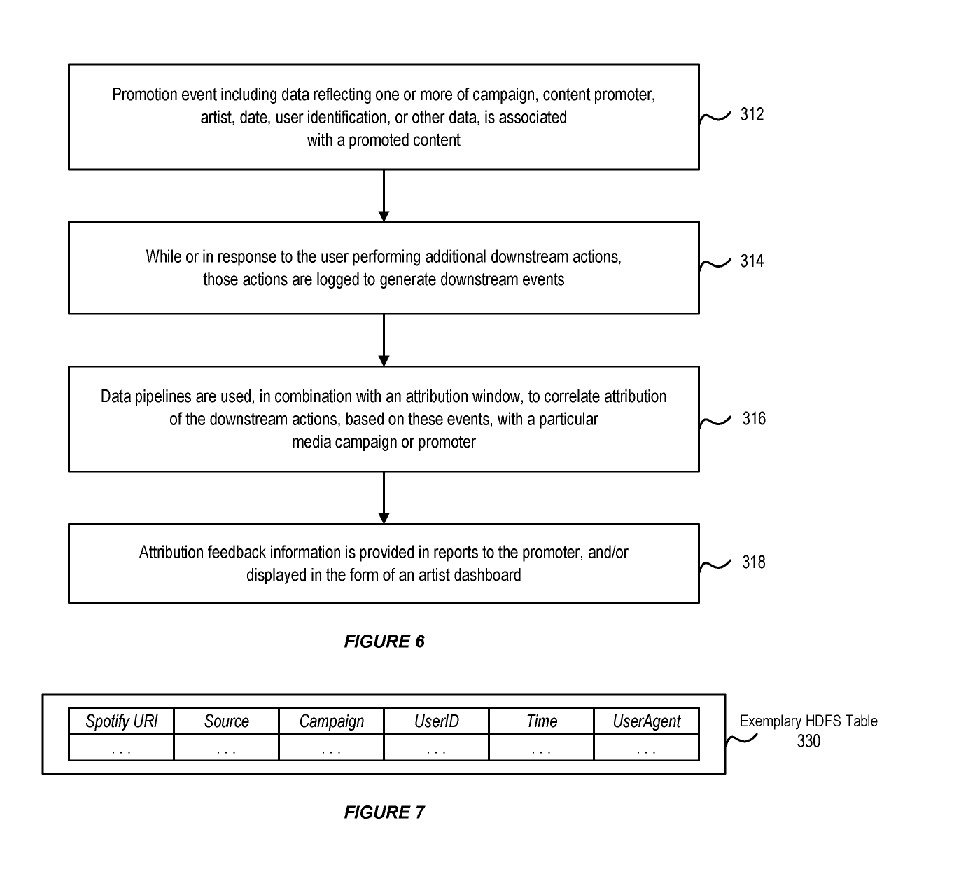

FIG. 6 is a flowchart that further illustrates a process for supporting attribution tracking for off-platform content promotion, in accordance with an embodiment. As illustrated in FIG. 6, at step 312, a promotion event including data reflecting one or more of a campaign, content promoter, artist, date, user identification, or other data, is associated with a promoted content.

At step 314, while or in response to the user performing additional downstream actions, those actions are logged to generate downstream events.

At step 316, data pipelines are used, in combination with an attribution window, to correlate attribution of the downstream actions, based on these events, with a particular media campaign or content promoter.

At step 318, attribution feedback information is provided in reports to the content promoter, and/or displayed in the form of an artist dashboard.

### Example Implementation

In accordance with an embodiment, a media content environment can use a URL-based campaign, for example as further described below, to enable off-platform content promotions to be trackable through downstream behaviors, based on selection of promoted content URLs, including: generating a URL link, which redirects to a client, and which is usable with publisher sites (e.g, Twitter, Facebook, or Google), or as one-off URLs for sources such as blogs or online articles; enabling clients to log the URL, together with an active user identification (e.g., a Spotify user ID); pushing such logs to a log/data storage/processor (e.g., HDFS); and, creating jobs to query the correlated downstream data to determine attributions.

In accordance with an embodiment, an, e.g., Google campaign format, can be used to determine the URL format, which assists in adding parameters to URLs to be used in custom web-based or email-based campaigns, and also supports link shortening.

In accordance with an embodiment, when a user/device selects a promoted content URL, any unique parameters associated with that link can be sent, e.g., to a Google Analytics environment, which can be used to identify those URLs most effective in attracting users to the promoted content, for example:
http://open.spotify.com/PATH?utm_source=<source>&utm_medium=<medium>& utm_campaign=<campaign_id>
   Where, for example:
utm_source=twitter|facebook (e.g., where the link is posted).
utm_medium=share (e.g., a unique value).
utm_campaign=a first level id (e.g., “internal”).
utm_content=unique content per link (e.g., a time-based, randomly generated, or hashed user value).

In accordance with an embodiment, a promoted content URL can be generated based on an indication of the publisher site (e.g., Twitter, Facebook, or Google), or on an external seed, for example by a computer program or code that accepts a track identifier and a publisher, and based on this, generates a URL with a unique campaign identifier.

In accordance with an embodiment, different types of media clients (e.g., based on Desktop, iOS, or Android) can process the URL and log metadata associated with events to the log/data storage/processor (e.g., HDFS). Each client can be configured appropriately to extract the metadata from the URL. In those instances where a media client is not installed, or there is no correlated user ID (for example, the media client is not launched), the system can log URL clicks, for use in determining attributions.

FIG. 7 illustrates an example (e.g., HDFS) table or data structure 330 that can be used to record activity data, in accordance with an embodiment.

The illustrated table or data structure, is provided by way of example, and in accordance with other embodiments, other types of tables, data structures, or types of activity data can be used. In accordance with an embodiment, queries can be created to display data visuals or information outlining desired campaign results. For example, the type of artist-related information that can be displayed can include: how many clicks resulted in a play event; or how many clicks resulted in a greater than 30-second stream.

### Example Client Implementation

In accordance with an embodiment, a media client (e.g., a Spotify client) can implement sending a client event with the following details:
Event id: link-tracking.
Sub event id: can be any unique value.
Extra data: A logged-in user data can be sent, together with client event data.
Referrer: A link, for example a URL link with which the client was opened (e.g., http://open.spotify.com), which may contain campaign tracking data.

In accordance with an embodiment, a client event will be sent when the media client is opened, and the opening informational data contains link specific referrer information (i.e., the client will not send a blank event if opened via tapping its icon).

The above-described examples of URL formats, parameters, and client activity data are provided for purposes of illustration, to illustrate a particular embodiment. In accordance with other embodiments, other types of URL formats, parameters, or client activity data can be used.

### Example Benefits

In accordance with an embodiment, benefits to content promoters and advertisers include the ability to measure the performance and impact of their driving promotions to the media content environment; coupled with feedback to optimize their promotion efforts; and confidence of a positive return on investment.

In accordance with an embodiment, benefits to artists include the ability to measure the performance and impact of promotions; with a similar opportunity for feedback; and a reduction in non-monetized plays through other services.

In accordance with an embodiment, benefits to media content environments include an increase in the traffic driven to the environment by content promoters, which provides more user engagement; and improved support for artist-direct services.

In accordance with an embodiment, benefits to users include minimal impact on existing user interfaces; and exposure to more relevant content.

Embodiments of the present invention may be conveniently implemented using one or more conventional general purpose or specialized computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a non-transitory storage medium or computer readable medium (media) having instructions stored thereon/in which can be used to program a computer to perform any of the processes of the present invention. Examples of the storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of embodiments of the present invention has been provided for the purposes of illustration and description. It is not intended to be exhaustive or to limit the invention to the precise forms disclosed. Many modifications and variations will be apparent to the practitioner skilled in the art.

For example, while the techniques described above generally illustrate examples such as a music streaming service such as Spotify, and streamed music or song content, the systems and techniques described herein can be similarly used with other types of media content environments, and other types of streamed data or media content.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

What is claimed is:

1. A system which supports attribution tracking for off-platform content promotion, for use in a media content or other computing environment, comprising:
one or more computers, including a media server executing thereon which receives requests from media clients for media content;
one or more data defining a media campaign, including
a promotion for a particular media content, and
a promoted content link for use as a promotion on a publisher site;
whereupon a selection of the particular promoted content link by a media device, the media device is redirected to a media content environment;
wherein a client activity data is logged and used to provide one or more of a campaign, content promoter, artist, date, user identification, or other data, to be recorded as a promotion event; and
wherein the promotion event is used to evaluate downstream actions by a user or the media device with regard to the promoted content.

2. The system of claim 1, wherein while or in response to the user or the media device performing additional downstream actions, the actions are logged to generate downstream events, and data pipelines used in combination with an attribution window, to correlate attribution of the actions, based on the events, with a particular media campaign or content promoter.

3. The system of claim 1, wherein a log/data storage/processor is used to evaluate the downstream actions with regard to the promoted content within a particular attribution window.

4. The system of claim 1, wherein the media server is used to stream music content.

5. The system of claim 1, wherein the client activity data is provided by a media client provided by or at the media device that enables selection and playing of media content.

6. A method of supporting attribution tracking for off-platform content promotion, for use in a media content or other computing environment, comprising:
providing at one or more computers, including a media server executing thereon which receives requests from media clients for media content;
providing one or more data defining a media campaign, including
a promotion for a particular media content, and
a promoted content link for use as a promotion on a publisher site;
whereupon a selection of the particular promoted content link by a media device, the media device is redirected to a media content environment;
wherein a client activity data is logged and used to provide one or more of a campaign, content promoter, artist, date, user identification, or other data, to be recorded as a promotion event; and
wherein the promotion event is used to evaluate downstream actions by a user or the media device with regard to the promoted content.

7. The method of claim 6, wherein while or in response to the user or the media device performing additional downstream actions, the actions are logged to generate downstream events, and data pipelines used in combination with an attribution window, to correlate attribution of the actions, based on the events, with a particular media campaign or content promoter.

8. The method of claim 6, wherein a log/data storage/processor is used to evaluate the downstream actions with regard to the promoted content within a particular attribution window.

9. The method of claim 6, wherein the media server is used to stream music content.

10. The method of claim 6, wherein the client activity data is provided by a media client provided by or at the media device that enables selection and playing of media content.

11. A non-transitory computer readable storage medium, including instructions stored thereon which when read and executed by one or more computers cause the one or more computers to perform the steps comprising:
providing at one or more computers, including a media server executing thereon which receives requests from media clients for media content;
providing one or more data defining a media campaign, including
a promotion for a particular media content, and
a promoted content link for use as a promotion on a publisher site;
whereupon a selection of the particular promoted content link by a media device, the media device is redirected to a media content environment;
wherein a client activity data is logged and used to provide one or more of a campaign, content promoter, artist, date, user identification, or other data, to be recorded as a promotion event; and
wherein the promotion event is used to evaluate downstream actions by a user or the media device with regard to the promoted content.

12. The non-transitory computer readable storage medium of claim 11, wherein while or in response to the user or the media device performing additional downstream actions, the actions are logged to generate downstream events, and data pipelines used in combination with an attribution window, to correlate attribution of the actions, based on the events, with a particular media campaign or content promoter.

13. The non-transitory computer readable storage medium of claim 11, wherein a log/data storage/processor is used to evaluate the downstream actions with regard to the promoted content within a particular attribution window.

14. The non-transitory computer readable storage medium of claim 11, wherein the media server is used to stream music content.

15. The non-transitory computer readable storage medium of claim 11, wherein the client activity data is provided by a media client provided by or at the media device that enables selection and playing of media content.
